(19) United States
(12) Patent Application Publication
(10) Pub. No.: US 2009/0092745 A1
(43) Pub. Date: Apr. 9, 2009

(54) Dopant material for manufacturing solar cells

(76) Inventors: Luca Pavani, Gilroy, CA (US); Bo Li, San Jose, CA (US)

Correspondence Address: Okamoto & Benedicto LLP, P.O. Box 641330, San Jose, CA, 95164-1330, US

(21) Appl. No.: 11/973,094

(22) Filed: Oct. 5, 2007

(51) Int. Cl. B05D 5/12; C09K 3/00

(52) U.S. Cl. 427/74; 252/501.1

(57) ABSTRACT

One embodiment relates to a dopant material for manufacturing solar cells. The dopant material includes a primary carrier and a dopant system. The primary carrier is a solid at a lower temperature, a liquid at an elevated temperature, and decomposes at a third temperature higher than the elevated temperature. The dopant material is dispensible in a controlled manner at the elevated temperature to a defined area of a silicon substrate at the lower temperature. The dopant system includes a dopant carrier and dopant source. The dopant source is stable at the third temperature. Other embodiments, aspects and features are also disclosed.

### BACKGROUND OF THE INVENTION

1. Technical Field

The present invention relates generally to solar cells, and more particularly but not exclusively to methods and apparatus for fabricating solar cells.

2. Description of the Background Art

Solar cells are well known devices for converting solar radiation to electrical energy. They may be fabricated on a semiconductor wafer using semiconductor processing technology. Generally speaking, a solar cell may be fabricated by forming p-doped and n-doped regions in a silicon substrate. Solar radiation impinging on the solar cell creates electrons and holes that migrate to the p-doped and n-doped regions, thereby creating voltage differentials between the doped regions. In a back side contact solar cell, the doped regions are coupled to metal contacts on the back side of the solar cell to allow an external electrical circuit to be coupled to and be powered by the solar cell. Back side contact solar cells are also disclosed in U.S. Pat. Nos. 6,998,288, 5,053,083 and 4,927,770, which are incorporated herein by reference in their entirety.

Methods and structures for lowering the cost of manufacturing solar cells are desirable as the savings can be passed on to consumers.

### SUMMARY

One embodiment relates to

These and other features of the present invention will be readily apparent to persons of ordinary skill in the art upon reading the entirety of this disclosure, which includes the accompanying drawings and claims.

### DESCRIPTION OF THE DRAWINGS

FIG. 1 is a schematic diagram showing a representation of a dopant material in accordance with an embodiment of the invention.

FIG. 2 is a schematic diagram showing a representation of a dopant material in accordance with specific embodiments of the invention.

FIG. 3 is a flow chart of a method of forming a dopant material and using the dopant material for doping a substrate of a solar cell in accordance with an embodiment of the invention.

FIGS. 4A and 4B are schematic diagrams depicting an ink jet apparatus for controllably dispensing the dopant material on a substrate for a solar cell in accordance with an embodiment of the invention.

FIG. 5 is a schematic diagram depicting a spray apparatus for rapidly dispensing the dopant material on a substrate for a solar cell in accordance with an embodiment of the invention.

FIG. 6 is a schematic diagram depicting a direct writing apparatus for controllably dispensing the dopant material on a substrate for a solar cell in accordance with an embodiment of the invention.

FIG. 7 is a schematic diagram showing an abstract representation of a dopant material including one or more functional components in accordance with an embodiment of the invention.

The use of the same reference label in different drawings indicates the same or like components. Drawings are not necessarily to scale unless otherwise noted.

### DETAILED DESCRIPTION

In the present application, numerous specific details are provided such as examples of apparatus, process parameters, materials, process steps, and structures to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

One problem or difficulty with the practical manufacture of an interdigitated back-contact solar cell relates to the high cost of fabrication, including the use of photoresist materials, processing and mask alignment, and so on. Thus, interdigitated back-contact solar cells have been typically restricted to high-value applications, such as high concentration solar cells.

The present application discloses a novel dopant material which is usable in an efficient manufacturing process. In particular, the dopant material is of a form which is suitable for being processed using ink jet printing, spraying, or other efficient dispensing techniques in the manufacturing of interdigitated back-contact silicon solar cells.

Advantageously, the dopant material may be jetted, sprayed, or dispensed at a lower viscosity compared to its standard viscosity at ambient temperature. With its higher viscosity at ambient temperature, the dopant material may be confined to localized areas by printing or otherwise dispensing fine features. Alternatively, the dopant material may be applied to cover portions or the whole area of the substrate using a spray nozzle, for example.

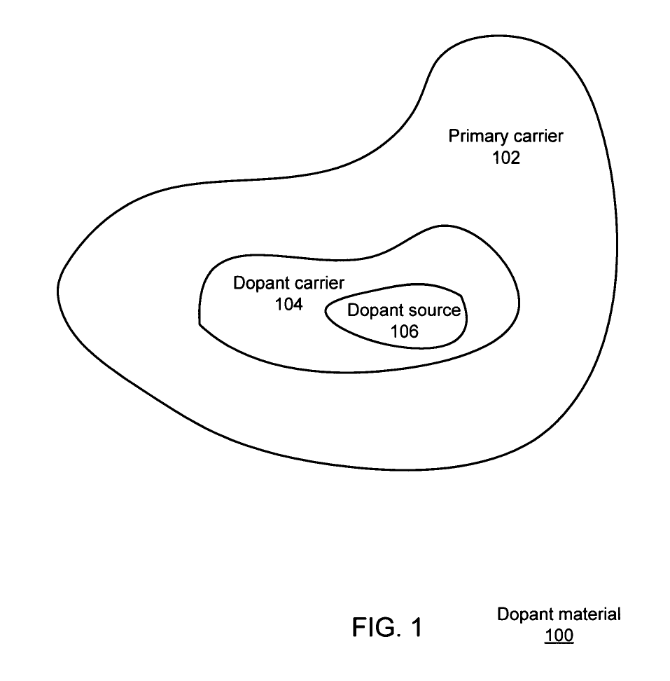

FIG. 1 is a schematic diagram showing a representation of a dopant material 100 in accordance with an embodiment of the invention. In accordance with this embodiment, the dopant material 100 may comprise a chemical mix of at least three main material components. These three main material components are a carrier material (primary material) 102, a dopant carrier (secondary material) 104, and a dopant source 106 embedded within the dopant carrier 104. The dopant material 100 is a blend of at least these three components. Optionally, one or more functional components may also be blended into the dopant material 100.

The carrier material 102 is phase sensitive to temperature, such as, for example, an organic wax material. The carrier material 102 may be in a lower-viscosity state, higher-viscosity state, or a decomposed state depending on the temperature and history of the material. The carrier material 102 may comprise, for example, an organic wax system. In accordance with a specific embodiment, the carrier material 102 may comprise stearic acid. In other embodiments, other fatty acids may be used to form the carrier material 102. In another embodiment, the carrier material 102 may comprise a thixotropic material which becomes more fluid (i.e. becomes lower in viscosity) as force is applied over time.

For purposes of dispensing, the carrier material 102 may be kept at an elevated temperature (higher than ambient temperature) so that it is in a lower-viscosity state. The lower-viscosity state is a liquid state. This allows for rapid dispensing by way of ink jet printing, spraying or other dispensing techniques.

Subsequently, at an ambient temperature, the carrier material 102 may be in the higher-viscosity state. The higher-viscosity state may be a solid state. This allows the carrier material 102 to be confined to localized areas after being dispensed on the substrate.

During further processing, the carrier material 102 (including the dopant carrier 104 and dopant source 106 blended therewith) may be placed in a higher-temperature, environment, such as an oven and/or a diffusion furnace, so as to drive the dopant source 106 into the substrate. At a given temperature, Temp α, which might or might not be lower than the dopant driving temperature Temp γ, the carrier material preferably breaks-down into a decomposed state.

The dopant carrier 104 and the dopant source 106 may be considered together to comprise a dopant system.

The dopant carrier 104 encloses the dopant source and is selected for compatibility with the carrier material. At a given temperature, Temp β, which may be equal or higher to the Temp α but lower than the Temp γ, the dopant carrier may or may not break-down into a decomposed state.

In accordance with one specific embodiment, the dopant carrier 104 may comprise tetraethoxysilane (TEOS) which typically would decompose at Temp β. In accordance with another specific embodiment, the dopant carrier 104 may comprise silicate, which typically would not decompose at Temp β.

On the other hand, the dopant source 106 is selected to be thermally stable at Temp β. In accordance with a specific embodiment, the dopant source 106 may comprise, for example, either boric oxide, B₂O₃, for p-type doping, or phosphorus pentoxide, P₂O₅, for n-type doping. Other dopant sources 106 may be used in other embodiments.

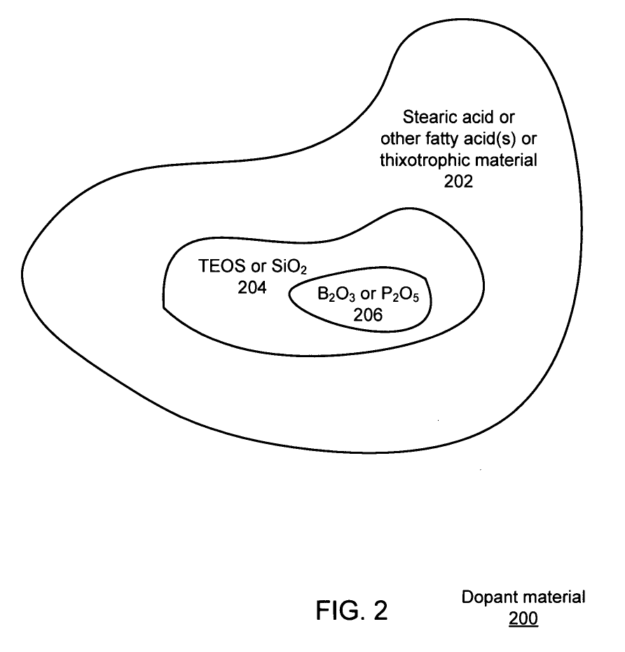

FIG. 2 is a schematic diagram showing a representation a dopant material 200 in accordance with specific embodiments of the invention. As depicted, the dopant material 200 may comprise stearic acid or other fatty acid(s) 202 as the primary carrier 102. The dopant material 200 may further comprise TEOS or SiO₂ 204 as the dopant carrier 104, and either boric oxide, B₂O₃ (for p-type doping) or phosphorus pentoxide, P₂O₅ (for n-type doping) as the dopant source 106. The substrate may specifically be a silicon wafer.

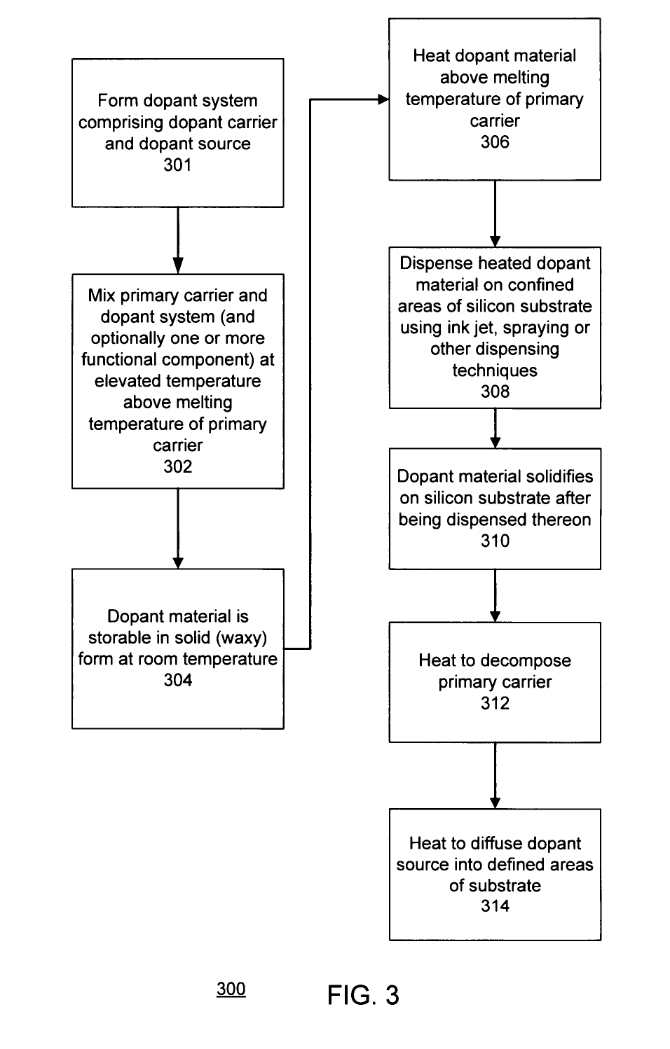

FIG. 3 is a flow chart of a method 300 of forming a dopant material and using the dopant material for doping a substrate of a solar cell in accordance with an embodiment of the invention. The first three blocks 301, 302, and 304 relate to forming and storing the dopant material.

Per block 301, the dopant system may be formed by mixing or blending together the dopant carrier and the dopant source. For example, the dopant carrier may comprise TEOS or silicate, and the dopant source may comprise B₂O₃ or P₂O₅. The dopant system includes the intermixed dopant carrier and dopant source. The dopant carrier is utilized for compatibility with the primary carrier.

Per block 302, the primary carrier and the dopant system (and optionally one or more functional component) are blended or mixed together at an elevated temperature. For example, the primary carrier may comprise a fatty acid, such as stearic acid, for example. The elevated temperature is sufficiently high so as to be above the melting temperature of the primary carrier. For example, the melting temperature of stearic acid is 70 degrees Celsius, so the elevated temperature is above that temperature. An expected range for the elevated temperature, depending on the specific primary carrier material used, is from about 60 degrees Celsius to 95 degrees Celsius.

Per block 304, the dopant material is storable in a solid (waxy) form or state at ambient or room temperature. This is because the primary carrier is such that it is in solid phase at room temperature (i.e. room temperature is below the melting temperature of the primary carrier).

The next four blocks 306, 308, 310, and 312 pertain to using the dopant material for doping a substrate of a solar cell. For such use, the dopant material may be taken out of storage in its solid form.

Per block 306, the dopant material is heated above the melting temperature of the primary carrier. By so heating the dopant material, the primary carrier will reach a liquid phase or a condition of low viscosity.

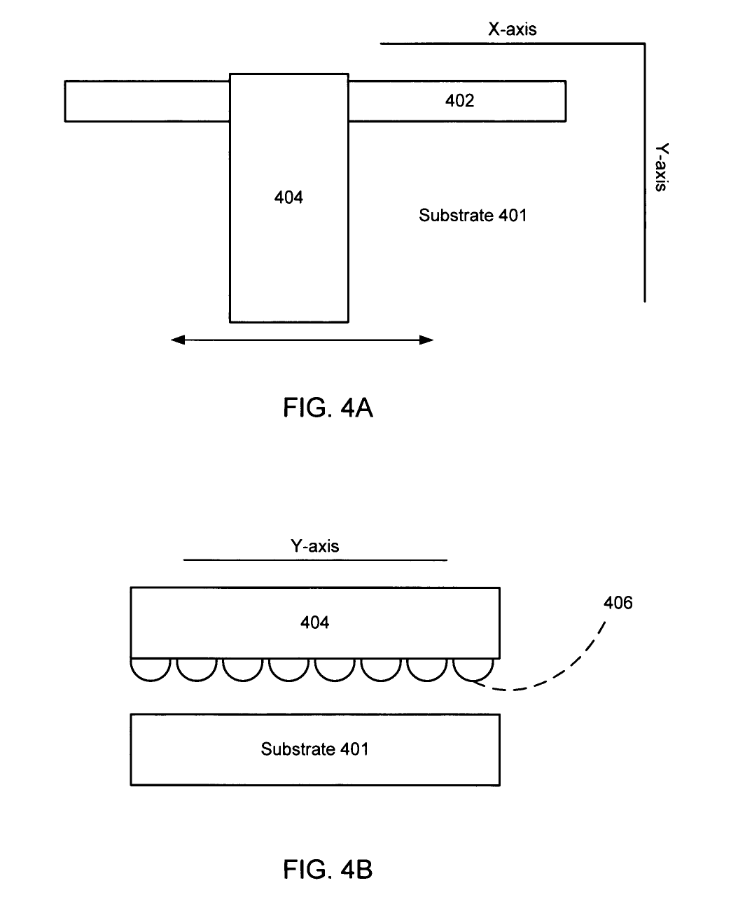

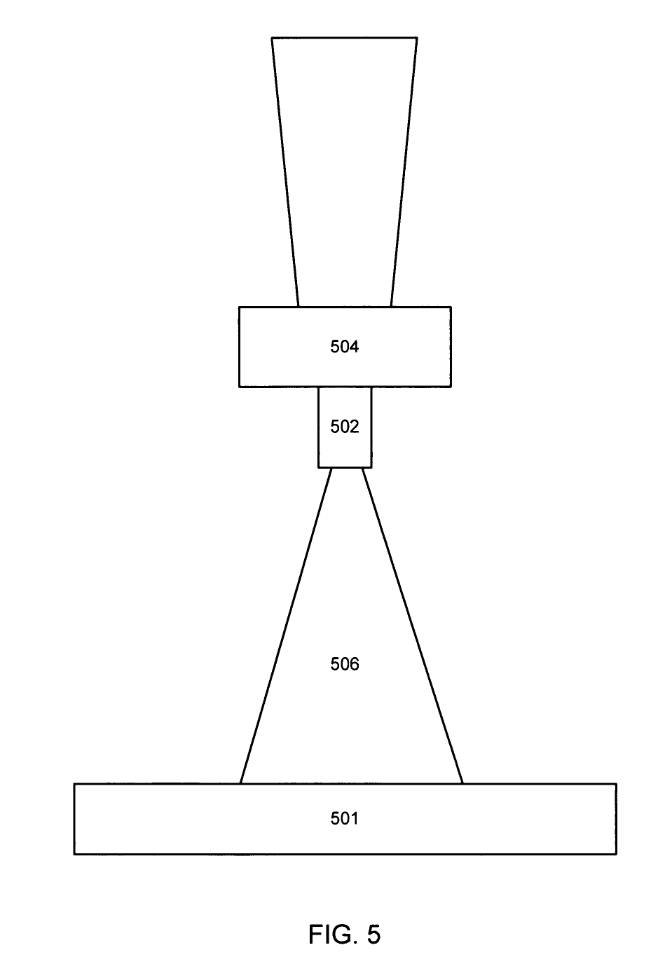

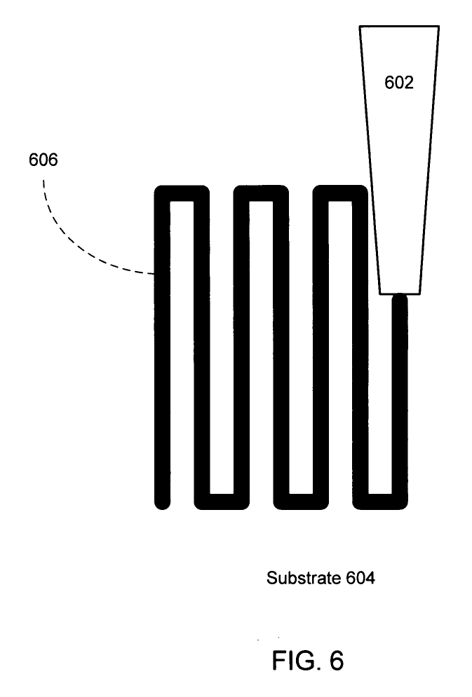

Per block 308, with the dopant material in a condition of low viscosity, the heated dopant material may be deposited on defined areas of a silicon substrate for a solar cell. The deposition may be performed by using, for example, an ink jet apparatus, a spraying apparatus, a direct writing apparatus, or other dispensing apparatus. An example ink jet apparatus is described below in relation to FIGS. 4A and 4B. An example spraying apparatus is described below in relation to FIG. 5, and an example direct writing apparatus is described below in relation to FIG. 6.

Per block 310, when the dopant material is deposited on the surface of the substrate for the solar cell, the dopant material solidifies or “freezes” in place. The solidification occurs because of a phase change from liquid to solid of the primary carrier. This phase change effect enables the dimension (length and width), the shape, and/or the thickness of the deposited dopant material to be controlled. For example, if an ink jet apparatus is used for dispensing, then the droplets jetted from a print head system will maintain their typical bubble shape once they are printed onto a silicon substrate which has a surface temperature that is cooler than the droplet temperature such that the droplet temperature is reduced below the melting temperature of the primary carrier. Hence, by generating printed features (such as dots, lines, and holes) and controlling their shapes and dimensions, the doping material may be localized to defined areas of the substrate.

Per block 312, after the material is deposited according to the desired pattern on the substrate, the substrate with the dopant material thereon may be heated so as to drive the dopant source into the defined areas of the substrate. In this step, the heating is performed to raise the temperature of the dopant material to a temperature, Temp α. Temp α is higher than the temperature at which the carrier material breaks-down into a decomposed state. As the carrier material decomposes, the dopant system is left upon the substrate. If the dopant carrier is such that it decomposes, then the dopant source itself is left upon the substrate.

Finally, per block 314, subsequent processing of the substrate and the dopant source at a given temperature Temp γ greater than Temp α may be used to diffuse the dopant source into the defined areas of the substrate. For example, at about 1,000 degrees Celsius, B₂O₃ may be driven into silicon via diffusion.

FIGS. 4A and 4B are schematic diagrams depicting an ink jet apparatus for controllably dispensing the dopant material on a substrate for a solar cell in accordance with an embodiment of the invention. FIG. 4A shows a planar view where an ink jet head 404 is configured to move along the x-axis direction by translation along a support 402 configured along the x-dimension. FIG. 4B shows a cross-sectional view of the ink jet head 404 above the substrate 401 being printed upon. Depicted on the underside of the ink jet head 404 is an array of dispensing elements 406 through which the dopant material may be controllably dispensed onto defined areas of the substrate 401.

FIG. 5 is a schematic diagram depicting a spray apparatus for rapidly dispensing the dopant material on a substrate for a solar cell in accordance with an embodiment of the invention. FIG. 5 shows a cross-sectional view of the spray head, including a spray nozzle 502 and an aerator 504 for generating a spray 506 of the dopant material so as to deposit the dopant material on a defined area of the substrate 501.

FIG. 6 is a schematic diagram depicting a direct writing apparatus for controllably dispensing the dopant material on a substrate for a solar cell in accordance with an embodiment of the invention. FIG. 6 shows a cross-sectional view of a direct writing head 602 dispensing a pattern of the dopant material 606 onto the substrate 604.

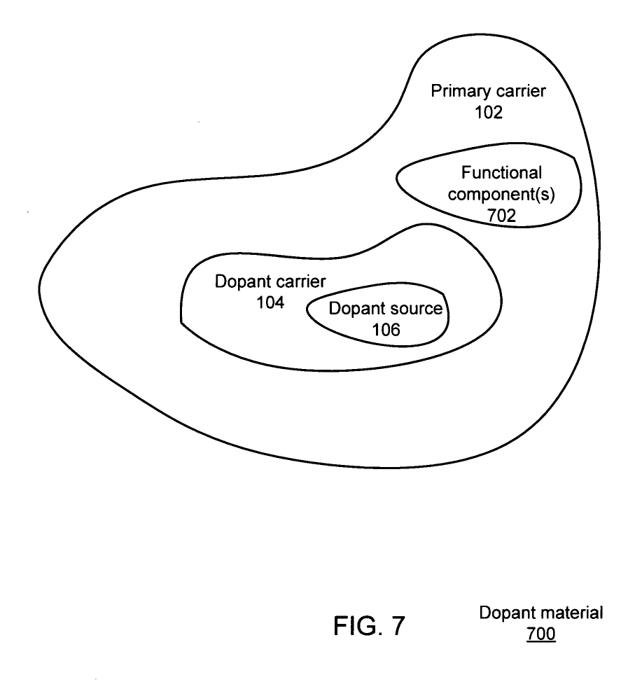

FIG. 7 is a schematic diagram showing an abstract representation of a dopant material 700 including one or more functional components 702 in accordance with an embodiment of the invention. The functional component or components 702 may be blended or mixed into the dopant material 700, for example, in step 302 of FIG. 3. The functional components 702 may comprise, for example, an adhesion promoter or a surfactant. Like the dopant carrier, the functional components may or may not decompose at Temp β.

An adhesion promoter may be added as a functional component 702 to increase the adhesion of the material deposited on the substrate during processing.

A surfactant may be added as a functional component 702 so as to enhance or contain the shape of the material applied onto the substrate surface. In other words, the surfactant enables the substrate surface to be wetted readily in a controlled manner. For example, the surfactant may be selected such that it increases the surface tension of the heated dopant material as it is deposited onto a silicon or silicon dioxide surface.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A dopant material for manufacturing solar cells, the dopant material comprising:
a primary carrier which has high viscosity at ambient temperature and is liquid with lower viscosity at an elevated temperature, and further which decomposes at a third temperature higher than the elevated temperature; and
a dopant system including a dopant carrier and dopant source,
wherein the dopant source is stable at the third temperature, and
wherein the dopant material is dispensible in a controlled manner at the elevated temperature to a defined area of a silicon substrate at the lower temperature.

2. The dopant material of claim 1, wherein the primary carrier comprises a fatty acid.

3. The dopant material of claim 2, wherein the primary carrier comprises stearic acid.

4. The dopant material of claim 1, wherein the primary carrier comprises a thixotrophic material.

5. The dopant material of claim 1, wherein the dopant carrier comprises TEOS.

6. The dopant material of claim 1, wherein the dopant carrier comprises silicate.

7. The dopant material of claim 1, wherein the dopant source comprises boric oxide.

8. The dopant material of claim 1, wherein the dopant source comprises phosphorus oxide.

9. The dopant material of claim 1, further comprising:
an adhesion promoter which increases adhesion of the dopant material onto the silicon substrate.

10. The dopant material of claim 1, further comprising:
a surfactant which modifies the surface tension of the dopant material as deposited onto the silicon substrate.

11. A method of manufacturing a dopant material for use in manufacturing solar cells, the method comprising:
mixing a primary carrier and a dopant system to form the dopant material, wherein the dopant system comprises a dopant carrier and a dopant source, and wherein the mixing is performed at an elevated temperature above a melting temperature of the primary carrier; and
storing the dopant material at a lower temperature which is below the melting temperature of the primary carrier.

12. The method of claim 11, wherein the primary carrier comprises a fatty acid.

13. The method of claim 12, wherein the primary carrier comprises stearic acid.

14. The method of claim 11, wherein the primary carrier comprises a thixotrophic material.

15. The method of claim 11, wherein the dopant carrier comprises TEOS.

16. The method of claim 11, wherein the dopant carrier comprises silicate.

17. The method of claim 11, wherein the dopant source comprises boric oxide.

18. The method of claim 11, wherein the dopant source comprises phosphorus oxide.

19. The method of claim 11, wherein an adhesion promoter which increases adhesion of the dopant material onto a silicon substrate is mixed into the dopant material.

20. The method of claim 11, wherein a surfactant which modifies surface tension of the dopant material as deposited onto a silicon substrate is mixed into the dopant material.

21. A method of manufacturing solar cells, the method comprising:
mixing a primary carrier and a dopant system to form a dopant material, wherein the dopant system comprises a dopant carrier and a dopant source, and wherein the mixing is performed at an elevated temperature above a melting temperature of the primary carrier;
dispensing the dopant material on defined areas of a silicon substrate, wherein the dopant material solidifies on the silicon substrate after being dispensed thereon; and
heating to decompose the primary carrier and the dopant carrier, and to diffuse the dopant source into the defined areas of the silicon substrate.
